(19) United States
(12) Patent Application Publication
(10) Pub. No.: US 2026/0331037 A1
(43) Pub. Date: Oct. 22, 2026

(54) DISPLAY PANEL AND ELECTRONIC DEVICE INCLUDING THE SAME

(71) Applicant: Samsung Display Co., Ltd., Yongin-si (KR)

(72) Inventors: Youngwan SEO, Yongin-si (KR); Hyunjoon KIM, Yongin-si (KR); Junghwan HWANG, Yongin-si (KR)

(73) Assignee: Samsung Display Co., Ltd., Yongin-si (KR)

(21) Appl. No.: 19/653,611

(22) Filed: Apr. 21, 2026

(30) Foreign Application Priority Data
Apr. 22, 2025 (KR) 10-2025-0052556

(51) Int. Cl. G09G 3/32

(52) U.S. Cl. CPC G09G 3/32; G09G 2300/043; G09G 2300/0819; G09G 2310/0267; G09G 2310/0275; G09G 2310/08; G09G 2340/0457

(57) ABSTRACT

A display panel including a pixel, the pixel including first light-emitting diode configured to emit light having first color, second light-emitting diode configured to emit light having second color, driving transistor including a gate connected to a first node, a first terminal, and a second terminal connected to a second node, write transistor configured to send a data signal to the first node, storage capacitor connected between the first and second nodes, first emission control transistor configured to connect the second node to a first terminal of the first light-emitting diode, and second emission control transistor configured to connect the second node to a first terminal of the second light-emitting diode. The display panel configured to display an image frame in a frame period including a first sub-frame period including first addressing and emission periods, and a following second sub-frame period including second addressing and emission periods.

### CROSS-REFERENCE TO RELATED APPLICATION

This application claims priority under 35 USC § 119 to Korean Patent Application No. 10-2025-0052556 filed on Apr. 22, 2025, in the Korean Intellectual Property Office (KIPO), the entire disclosure of which is incorporated by reference herein.

### BACKGROUND

### 1. Field

Some example embodiments relate to display devices. For example, some example embodiments relate to pixels, display panels including the pixels, and/or electronic devices including the display panels.

### 2. Description of the Related Art

A display device may include pixels. Each of the pixels may include a plurality of transistors. A resolution of the display device may be defined by the number of pixels included in the display device. As the number of pixels included in the display device increases, the resolution of the display device may increase.

In order to improve display quality of the display device, the number of transistors included in the pixel may increase. However, as the number of transistors included in the pixel increases, an area of the pixel may increase, and accordingly, increasing the resolution of the display device may be limited or reduced.

### SUMMARY

Some embodiments provide display panels with an increased resolution including pixels with reduced areas.

Some embodiments provide electronic devices including display panels with increased resolution.

In a display panel including a pixel according to some example embodiments, the pixel includes a first light-emitting diode configured to emit light having a first color, a second light-emitting diode configured to emit light having a second color different from the first color, a driving transistor including a gate connected to a first node, a first terminal, and a second terminal connected to a second node, a first write transistor configured to send a first data signal to the first node in response to a first write gate signal, a storage capacitor connected between the first node and the second node, a first emission control transistor configured to connect the second node to a first terminal of the first light-emitting diode in response to a first emission control signal, and a second emission control transistor configured to connect the second node to a first terminal of the second light-emitting diode in response to a second emission control signal. The display panel is configured to display an image frame in a frame period, the frame period including a first sub-frame period including a first addressing period that a first data voltage is applied to the first node and a first emission period that the first light-emitting diode is configured to emit light with a luminance corresponding to the first data voltage, and a second sub-frame period following the first sub-frame period, and the second sub-frame period including a second addressing period that a second data voltage is applied to the first node and a second emission period that the second light-emitting diode is configured to emit light with a luminance corresponding to the second data voltage.

In some example embodiments, the pixel may further include a compensation transistor configured to send a first power voltage to the first terminal of the driving transistor in response to a compensation gate signal.

In some example embodiments, the pixel may further include a holding capacitor connected between the second node and a reference line configured to send a reference voltage.

In some example embodiments, the first data signal may have the first data voltage in the first addressing period and the second data voltage in the second addressing period.

In some example embodiments, the first sub-frame period may further include a first initialization period that a reference voltage is applied to the first node and a first compensation period that a value obtained by subtracting a threshold voltage of the driving transistor from the reference voltage is applied to the second node. The second sub-frame period may further include a second initialization period that the reference voltage is applied to the first node and a second compensation period that the value obtained by subtracting the threshold voltage of the driving transistor from the reference voltage is applied to the second node.

In some example embodiments, the first data signal may have the reference voltage in the first initialization period, the first compensation period, the second initialization period, and the second compensation period.

In some example embodiments, the pixel may further include a third light-emitting diode configured to emit light having a third color different from the first color and the second color, and a third emission control transistor configured to connect the second node to a first terminal of the third light-emitting diode in response to a third emission control signal.

In some example embodiments, the frame period may further include a third sub-frame period following the second sub-frame period, and the third sub-frame period including a third addressing period that a third data voltage is applied to the first node and a third emission period that the third light-emitting diode is configured to emit light with a luminance corresponding to the third data voltage.

In some example embodiments, the driving transistor may be an n-channel metal oxide semiconductor (NMOS) transistor.

In some example embodiments, each of the first write transistor, the first emission control transistor, and the second emission control transistor may be an NMOS transistor.

In some example embodiments, each of the first write transistor, the first emission control transistor, and the second emission control transistor may be a p-channel metal oxide semiconductor (PMOS) transistor.

In some example embodiments, at least one of the first write transistor, the first emission control transistor, and the second emission control transistor may be an NMOS transistor. At least one other one of the first write transistor, the first emission control transistor, and the second emission control transistor may be a PMOS transistor.

In some example embodiments, the pixel may further include a second write transistor configured to send a second data signal to the first node in response to a second write gate signal, and a third write transistor configured to send a third data signal to the first node in response to a third write gate signal.

An electronic device, according to some example embodiments, includes a display panel including pixels, a gate driver configured to output a first write gate signal to each pixel of the pixels, an emission driver configured to output a first emission control signal and a second emission control signal to each pixel of the pixels, and a data driver configured to output a first data signal to each pixel of the pixels. Each pixel of the pixels including a first light-emitting diode configured to emit light having a first color, a second light-emitting diode configured to emit light having a second color different from the first color, a driving transistor including a gate connected to a first node, a first terminal, and a second terminal connected to a second node, a first write transistor configured to send the first data signal to the first node in response to the first write gate signal, a storage capacitor connected between the first node and the second node, a first emission control transistor configured to connect the second node to a first terminal of the first light-emitting diode in response to the first emission control signal, and a second emission control transistor configured to connect the second node to a first terminal of the second light-emitting diode in response to the second emission control signal. The display panel configured to display an image frame in a frame period, the frame period including a first sub-frame period including a first addressing period that a first data voltage is applied to the first node and a first emission period that the first light-emitting diode is configured to emit light with a luminance corresponding to the first data voltage, and a second sub-frame period following the first sub-frame period, and the second sub-frame period including a second addressing period that a second data voltage is applied to the first node and a second emission period that the second light-emitting diode is configured to emit light with a luminance corresponding to the second data voltage.

In some example embodiments, the gate driver may further be configured to output a compensation gate signal to each pixel of the pixels. Each pixel of the pixels may further include a compensation transistor configured to send a first power voltage to the first terminal of the driving transistor in response to the compensation gate signal.

In some example embodiments, the first write gate signal may be sequentially sent to pixel rows of the display panel.

In some example embodiments, the first emission control signal, the second emission control signal, and the compensation gate signal may be simultaneously sent to pixel rows of the display panel.

In some example embodiments, each pixel of the pixels may further include a holding capacitor connected between the second node and a reference line configured to send a reference voltage.

In some example embodiments, the driving transistor may be an n-channel metal oxide semiconductor (NMOS) transistor.

In some example embodiments, each of the first write transistor, the first emission control transistor, and the second emission control transistor may be an NMOS transistor.

In the pixel of the display panel according to some example embodiments, sub-pixels share transistors and capacitors, and the sub-pixels sequentially emit light in the frame period, so that the area of the pixel may be reduced.

In the display panel and/or the electronic device according to some example embodiments, the area of the pixel is reduced, so that the resolution of the display panel may increase and/or improve.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a display device according to some example embodiments.

FIG. 2 is a circuit diagram illustrating an example of a pixel of FIG. 1, according to some example embodiments.

FIG. 3 is a timing diagram illustrating voltages and signals of FIG. 2, according to some example embodiments.

FIG. 4 is a diagram for describing a first initialization period to a third initialization period of FIG. 3, according to some example embodiments.

FIG. 5 is a diagram for describing a first compensation period to a third compensation period of FIG. 3, according to some example embodiments.

FIG. 6 is a diagram for describing a first addressing period to a third addressing period of FIG. 3, according to some example embodiments.

FIG. 7 is a diagram for describing a first emission period of FIG. 3, according to some example embodiments.

FIG. 8 is a diagram for describing a second emission period of FIG. 3, according to some example embodiments.

FIG. 9 is a diagram for describing a third emission period of FIG. 3, according to some example embodiments.

FIG. 10 is a circuit diagram illustrating a pixel according to the prior art.

FIG. 11 is a timing diagram illustrating voltages and signals of FIG. 10.

FIG. 12 is a circuit diagram illustrating an example of a pixel of FIG. 1, according to some example embodiments.

FIG. 13 is a circuit diagram illustrating an example of a pixel of FIG. 1, according to some example embodiments.

FIG. 14 is a block diagram illustrating a display device according to some example embodiments.

FIG. 15 is a circuit diagram illustrating an example of a pixel of FIG. 14, according to some example embodiments.

FIG. 16 is a block diagram illustrating a display device according to some example embodiments.

FIG. 17 is a circuit diagram illustrating an example of a pixel of FIG. 16, according to some example embodiments.

FIG. 18 is a block diagram illustrating an electronic device according to some example embodiments.

FIG. 19 is a diagram illustrating electronic devices according to some example embodiments.

### DETAILED DESCRIPTION

Hereinafter, a display panel and/or an electronic device, according to some example embodiments of the present inventive concepts, will be described in more detail with reference to the accompanying drawings. The same or similar reference numerals will be used for the same elements in the accompanying drawings.

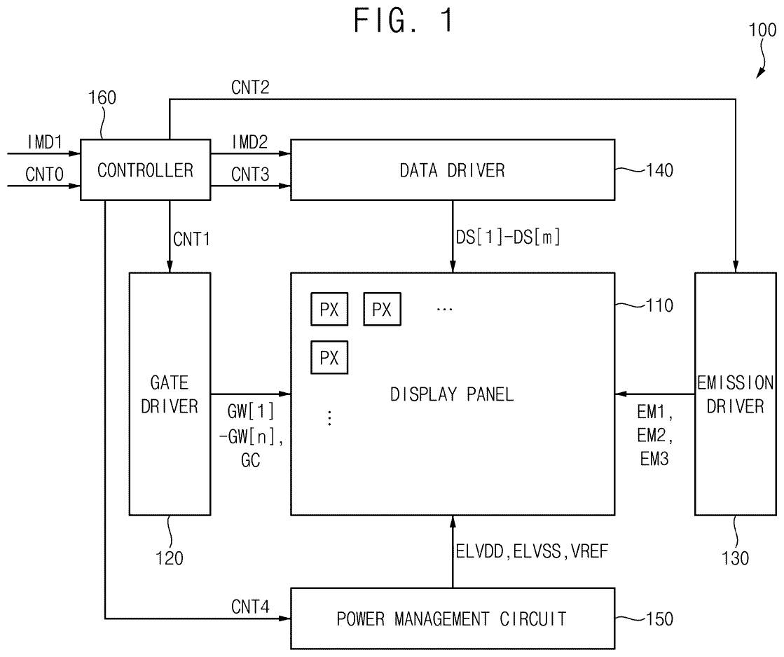

FIG. 1 is a block diagram illustrating a display device 100 according to some example embodiments.

Referring to FIG. 1, the display device 100 may include a display panel 110, a gate driver 120, an emission driver 130, a data driver 140, a power management circuit 150, and a controller 160.

The display panel 110 may display an image. The display panel 110 may display image frames in frame periods, respectively. For example, one frame period may be a period in which one image frame is displayed. Accordingly, the image displayed by the display panel 110 may include the image frames. For example, the display panel 110 may display a plurality of frames in a plurality of frame periods, respectively, and, for example, at least one frame period of the plurality of frame periods may be a frame period in which at least one frame image of the plurality of frame images may be displayed by the display panel 110.

The display panel 110 may include pixels PX (e.g., a plurality of pixels PX). The pixels PX may emit light in the frame period, and the image frame may include the light emitted from the pixels PX. For example, the display panel 110 may include first to n^{th} pixel rows in which the pixels PX are arranged and first to m^{th} pixel columns, where each of n and m is a natural number greater than or equal to 2.

The display panel 110 may include a display area and a non-display area. The pixels PX may be arranged in the display area. The non-display area may surround at least a portion of the display area.

The gate driver 120 may provide first to n^{th} write gate signals GW[1]-GW[n] and a compensation gate signal GC to the pixels PX. The gate driver 120 may generate the first to n^{th} write gate signals GW[1]-GW[n] and the compensation gate signal GC based on a first control signal CNT1. The first control signal CNT1 may include a gate clock signal, a gate start signal, etc. In some example embodiments, the gate driver 120 may be formed and/or mounted in the non-display area of the display panel 110.

The emission driver 130 may provide a first emission control signal EM1, a second emission control signal EM2, and a third emission control signal EM3 to the pixels PX. The emission driver 130 may generate the first emission control signal EM1, the second emission control signal EM2, and the third emission control signal EM3 based on a second control signal CNT2. The second control signal CNT2 may include an emission clock signal, an emission start signal, etc. In some example embodiments, the emission driver 130 may be formed and/or mounted in the non-display area of the display panel 110.

In some example embodiments, the first to n^{th} write gate signals GW[1]-GW[n] may be sequentially transmitted and/or sent to the first to n^{th} pixel rows. In some example embodiments, an i^{th} write gate signal GW[i] transmitted and/or sent to an i^{th} pixel row may be different from an i-1^{th} write gate signal GW[i-1] transmitted and/or sent to an i-1^{th} pixel row, where i is a natural number greater than or equal to 1 and less than or equal to n. For example, the first to n^{th} write gate signals GW[1]-GW[n] may be shifted by one horizontal time interval.

In some example embodiments, the compensation gate signal GC, the first emission control signal EM1, the second emission control signal EM2, and the third emission control signal EM3 may be simultaneously transmitted and/or sent to the first to n^{th} pixel rows. The compensation gate signal GC, the first emission control signal EM1, the second emission control signal EM2, and the third emission control signal EM3 transmitted and/or sent to the i^{th} pixel row may be the same as the compensation gate signal GC, the first emission control signal EM1, the second emission control signal EM2, and the third emission control signal EM3 transmitted to the i-1^{th} pixel row, respectively.

The data driver 140 may provide first to m^{th} data signals DS[1]-DS[m] to the pixels PX. The data driver 140 may generate the first to m^{th} data signals DS[1]-DS[m] based on output image data IMD2 and a third control signal CNT3. The output image data IMD2 may include grayscale values corresponding to the pixels PX. The third control signal CNT3 may include a data clock signal, a load signal, an output data enable signal, etc. In some example embodiments, the data driver 140 may be implemented as a single integrated circuit IC together with the controller 160, but example embodiments are not limited thereto. In some example embodiments, the data driver 140 may be implemented as an independent integrated circuit from the controller 160.

The power management circuit 150 may provide a first power voltage ELVDD, a second power voltage ELVSS, and a reference voltage VREF to the pixels PX. The power management circuit 150 may generate the first power voltage ELVDD, the second power voltage ELVSS, and the reference voltage VREF based on a fourth control signal CNT4. In some example embodiments, the power management circuit 150 may be implemented as an integrated circuit, but example embodiments are not limited thereto.

The controller 160 may control the gate driver 120, the emission driver 130, the data driver 140, and the power management circuit 150. The controller 160 may provide the first control signal CNT1 to the gate driver 120, may provide the second control signal CNT2 to the emission driver 130, may provide the output image data IMD2 and the third control signal CNT3 to the data driver 140, and may provide the fourth control signal CNT4 to the power management circuit 150. The controller 160 may generate the output image data IMD2, the first control signal CNT1, the second control signal CNT2, the third control signal CNT3, and the fourth control signal CNT4 based on input image data IMD1 and a control signal CNT0 (e.g., an initial control signal CNT0). The controller 160 may convert grayscale values of the input image data IMD1 into the grayscale values of the output image data IMD2. The control signal CNT0 may include a vertical synchronization signal, a horizontal synchronization signal, a master clock signal, an input data enable signal, etc.

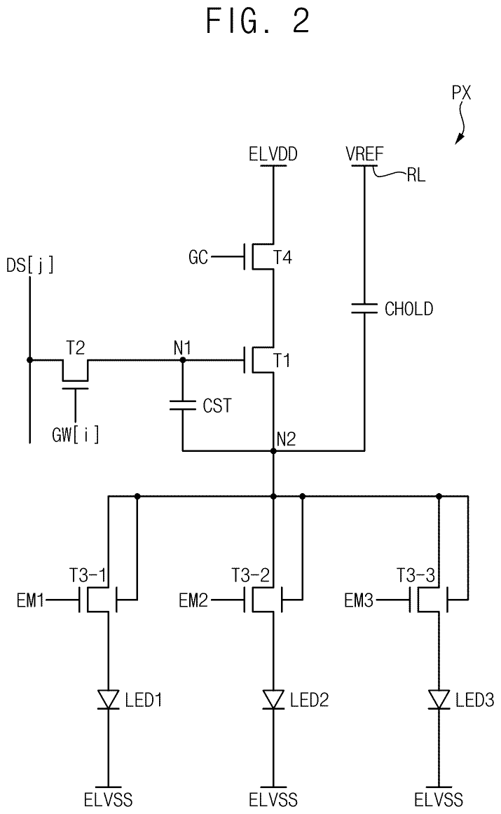

FIG. 2 is a circuit diagram illustrating an example of the pixel PX of FIG. 1, according to some example embodiments. FIG. 2 may illustrate a pixel PX positioned in the i^{th} pixel row and a j^{th} pixel column.

Referring to FIG. 2, the pixel PX may receive the write gate signal GW[i], the first emission control signal EM1, the second emission control signal EM2, the third emission control signal EM3, the compensation gate signal GC, the data signal DS[j], the first power voltage ELVDD, the second power voltage ELVSS, and the reference voltage VREF. The pixel PX may include a first light-emitting diode LED1, a second light-emitting diode LED2, a third light-emitting diode LED3, a driving transistor T1, a write transistor T2, a first emission control transistor T3-1, a second emission control transistor T3-2, a third emission control transistor T3-3, a compensation transistor T4, a storage capacitor CST, and a holding capacitor CHOLD.

The first light-emitting diode LED1 may emit light having a first color. For example, the first color may be red. The first light-emitting diode LED1 may include a first terminal (e.g., an anode) and a second terminal (e.g., a cathode) that receives the second power voltage ELVSS.

The second light-emitting diode LED2 may emit light having a second color different from the first color. For example, the second color may be green. The second light-emitting diode LED2 may include a first terminal (e.g., an anode) and a second terminal (e.g., a cathode) that receives the second power voltage ELVSS.

The third light-emitting diode LED3 may emit light having a third color different from the first color and the second color. For example, the third color may be blue. The third light-emitting diode LED3 may include a first terminal (e.g., an anode) and a second terminal (e.g., a cathode) that receives the second power voltage ELVSS.

In some example embodiments, each of the first light-emitting diode LED1, the second light-emitting diode LED2, and the third light-emitting diode LED3 may be one of an organic light-emitting diode, an inorganic light-emitting diode, and/or a quantum dot light-emitting diode.

The driving transistor T1 may include a gate connected to a first node N1, a first terminal (e.g., a drain), and a second terminal (e.g., a source) connected to a second node N2. The driving transistor T1 may generate a driving current corresponding to a voltage difference between the first node N1 and the second node N2. In some example embodiments, the driving transistor T1 may be an n-channel metal oxide semiconductor (NMOS) transistor.

The write transistor T2 may transmit and/or send the data signal DS[j] to the first node N1 in response to the write gate signal GW[i]. The write transistor T2 may include a gate that receives the write gate signal GW[i], a first terminal (e.g., one of a source and a drain) that receives the data signal DS[j], and a second terminal (e.g., the other one of the source and the drain) connected to the first node N1.

The first emission control transistor T3-1 may connect the second node N2 to the first terminal of the first light-emitting diode LED1 in response to the first emission control signal EM1. The first emission control transistor T3-1 may include a gate that receives the first emission control signal EM1, a first terminal (e.g., one of a source and a drain) connected to the second node N2, and a second terminal (e.g., the other one of the source and the drain) connected to the first terminal of the first light-emitting diode LED1. In some example embodiments, the first emission control transistor T3-1 may further include a back gate (or, e.g., a bottom gate) connected to the second node N2.

The second emission control transistor T3-2 may connect the second node N2 to the first terminal of the second light-emitting diode LED2 in response to the second emission control signal EM2. The second emission control transistor T3-2 may include a gate that receives the second emission control signal EM2, a first terminal (e.g., one of a source and a drain) connected to the second node N2, and a second terminal (e.g., the other one of the source and the drain) connected to the first terminal of the second light-emitting diode LED2. In some example embodiments, the second emission control transistor T3-2 may further include a back gate (or, e.g., bottom gate) connected to the second node N2.

The third emission control transistor T3-3 may connect the second node N2 to the first terminal of the third light-emitting diode LED3 in response to the third emission control signal EM3. The third emission control transistor T3-3 may include a gate that receives the third emission control signal EM3, a first terminal (e.g., one of a source and a drain) connected to the second node N2, and a second terminal (e.g., the other one of the source and the drain) connected to the first terminal of the third light-emitting diode LED3. In some example embodiments, the third emission control transistor T3-3 may further include a back gate (or, e.g., bottom gate) connected to the second node N2.

The compensation transistor T4 may transmit and/or send the first power voltage ELVDD to the first terminal of the driving transistor T1 in response to the compensation gate signal GC. The compensation transistor T4 may include a gate that receives the compensation gate signal GC, a first terminal (e.g., one of a source and a drain) that receives the first power voltage ELVDD, and a second terminal (e.g., the other one of the source and the drain) connected to the first terminal of the driving transistor T1.

In some example embodiments, each of the write transistor T2, the first emission control transistor T3-1, the second emission control transistor T3-2, the third emission control transistor T3-3, and the compensation transistor T4 may be an NMOS transistor.

The storage capacitor CST may be connected between the first node N1 and the second node N2. The storage capacitor CST may store the voltage difference between the first node N1 and the second node N2.

The holding capacitor CHOLD may be connected between the second node N2 and a reference line RL that transmits and/or sends the reference voltage VREF. The holding capacitor CHOLD may maintain a voltage of the second node N2. The back gate of the first emission control transistor T3-1, the back gate of the second emission control transistor T3-2, and the back gate of the third emission control transistor T3-3 may be connected to the second node N2, and accordingly, driving characteristics of the first emission control transistor T3-1, driving characteristics of the second emission control transistor T3-2, and driving characteristics of the third emission control transistor T3-3 may be improved by the holding capacitor CHOLD.

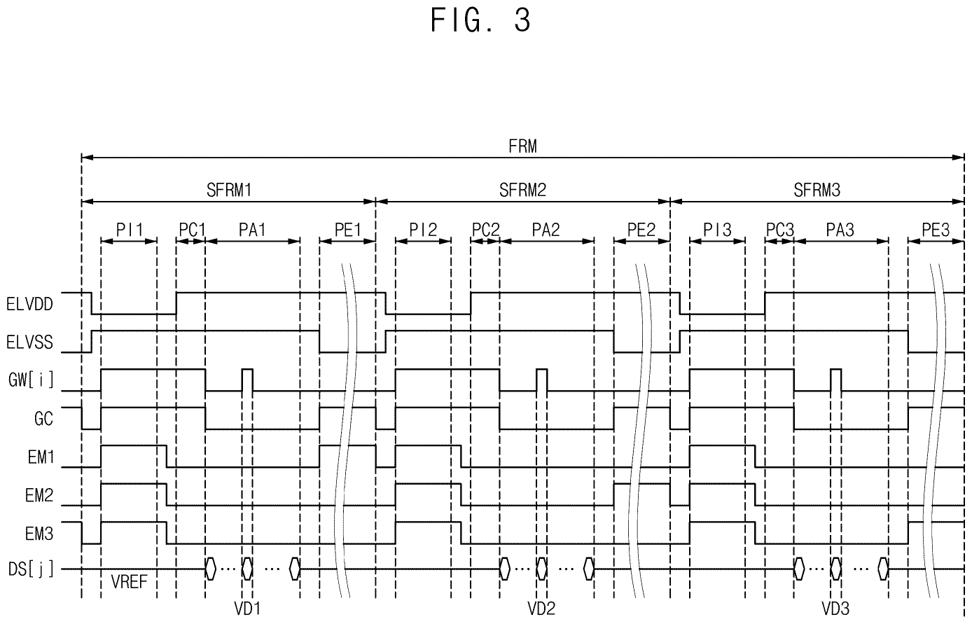

FIG. 3 is a timing diagram illustrating voltages and signals of FIG. 2, according to some example embodiments.

Referring to FIGS. 2 and 3, a frame period FRM may include a first sub-frame period SFRM1, a second sub-frame period SFRM2, and a third sub-frame period SFRM3. The second sub-frame period SFRM2 may follow the first sub-frame period SFRM1, and the third sub-frame period SFRM3 may follow the second sub-frame period SFRM2. In some example embodiments, at least one frame period FRM of a plurality of frame periods FRMs may include a plurality of sub-frame periods SFRMs, and, for example, the plurality of sub-frame periods SFRMs may occur sequentially in the at least one frame period FRM of the plurality of the plurality of frame periods FRMs. In some example embodiments, the at least one frame period FRM may include one or more sub-frame periods SFRMs (e.g., a first sub-frame period SFRM1, a second sub-frame period SFRM2, and a third sub-frame period SFRM3). While FIG. 3 illustrates that the at least one frame period FRM includes three sub-frame periods (e.g., SFRM1, SFRM2, and SFRM3), example embodiments are not limited thereto, and the at least one frame period FRM may include three or more sub-frame periods SFRMs.

In some example embodiments, the first sub-frame period SFRM1 may include a first initialization period PI1, a first compensation period PC1, a first addressing period PA1, and a first emission period PE1. The second sub-frame period SFRM2 may include a second initialization period PI2, a second compensation period PC2, a second addressing period PA2, and a second emission period PE2. The third sub-frame period SFRM3 may include a third initialization period PI3, a third compensation period PC3, a third addressing period PA3, and a third emission period PE3.

The first power voltage ELVDD may have a low voltage level in the first to third initialization periods PI1, PI2, and PI3, and may have a high voltage level in the first to third compensation periods PC1, PC2, and PC3, the first to third addressing periods PA1, PA2, and PA3, and the first to third emission periods PE1, PE2, and PE3. The second power voltage ELVSS may have a high voltage level in the first to third initialization periods PI1, PI2, and PI3, the first to third compensation periods PC1, PC2, and PC3, and the first to third addressing periods PA1, PA2, and PA3, and may have a low voltage level in the first to third emission periods PE1, PE2, and PE3.

The write gate signal GW[i] may have a high voltage level in the first to third initialization periods PI1, PI2, and PI3 and the first to third compensation periods PC1, PC2, and PC3. The write gate signal GW[i] may include a pulse having the high voltage level in each of the first to third addressing periods PA1, PA2, and PA3, and may have a low voltage level in the first to third emission periods PE1, PE2, and PE3. The compensation gate signal GC may have a high voltage level in the first to third initialization periods PI1, PI2, and PI3, the first to third compensation periods PC1, PC2, and PC3, and the first to third emission periods PE1, PE2, and PE3, and may have a low voltage level in the first to third addressing periods PA1, PA2, and PA3.

The first emission control signal EM1 may have a high voltage level in the first to third initialization periods PI1, PI2, and PI3 and the first emission period PE1. The first emission control signal EM1 may have a low voltage level in the first to third compensation periods PC1, PC2, and PC3, the first to third addressing periods PA1, PA2, and PA3, and the second and third emission periods PE2 and PE3. The second emission control signal EM2 may have a high voltage level in the first to third initialization periods PI1, PI2, and PI3 and the second emission period PE2. The second emission control signal EM2 may have a low voltage level in the first to third compensation periods PC1, PC2, and PC3, the first to third addressing periods PA1, PA2, and PA3, and the first and third emission periods PE1 and PE3. The third emission control signal EM3 may have a high voltage level in the first to third initialization periods PI1, PI2, and PI3 and the third emission period PE3. The third emission control signal EM3 may have a low voltage level in the first to third compensation periods PC1, PC2, and PC3, the first to third addressing periods PA1, PA2, and PA3, and the first and second emission periods PE1 and PE2.

The data signal DS[j] may have the reference voltage VREF in the first to third initialization periods PI1, PI2, and PI3, the first to third compensation periods PC1, PC2, and PC3, and the first to third emission periods PE1, PE2, and PE3. The data signal DS[j] may have a first data voltage VD1 in the first addressing period PA1, a second data voltage VD2 in the second addressing period PA2, and a third data voltage VD3 in the third addressing period PA3. For example, the first data voltage VD1 may be a red data voltage, the second data voltage VD2 may be a green data voltage, and the third data voltage VD3 may be a blue data voltage.

Hereinafter, an operation of the pixel PX in the frame period FRM (e.g., in the at least one frame period FRM) will be described with reference to FIGS. 3 to 9, according to some example embodiments.

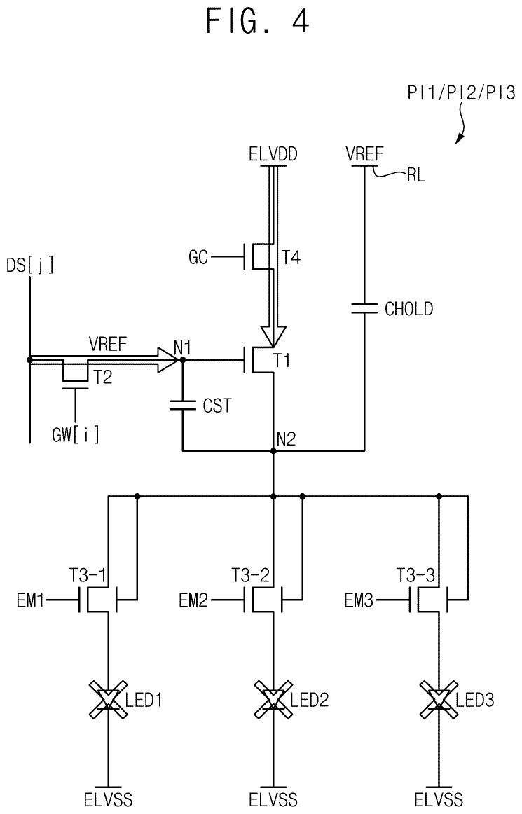

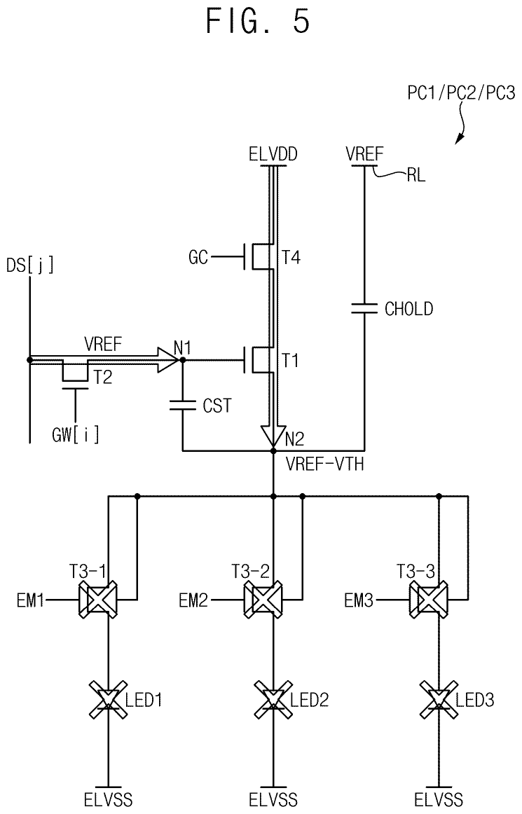

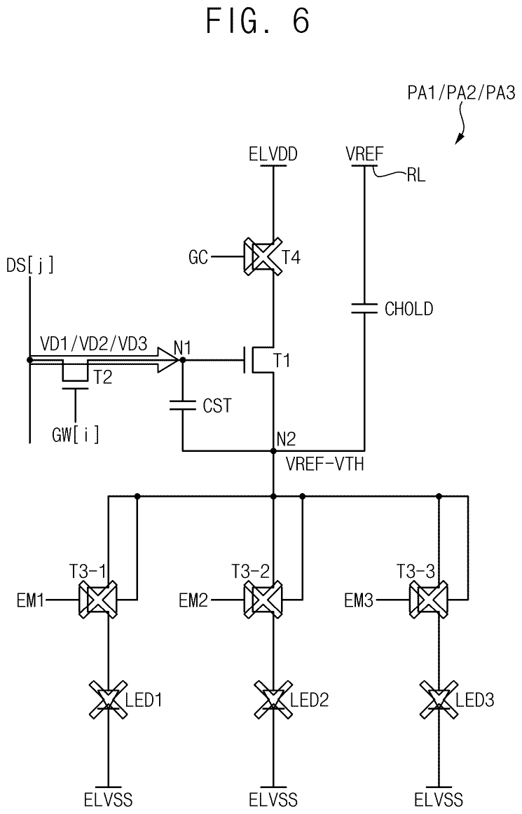

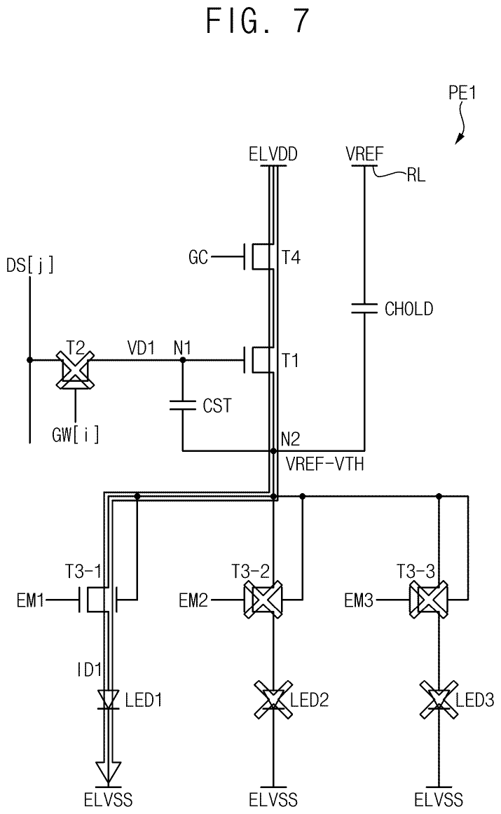

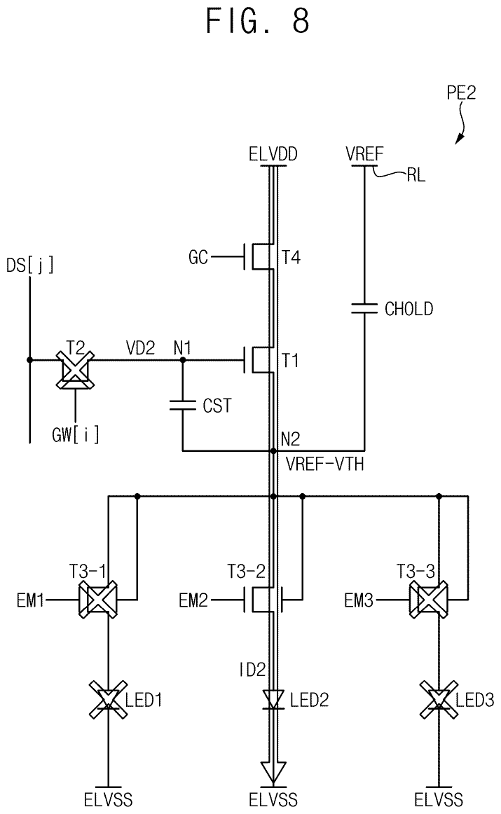

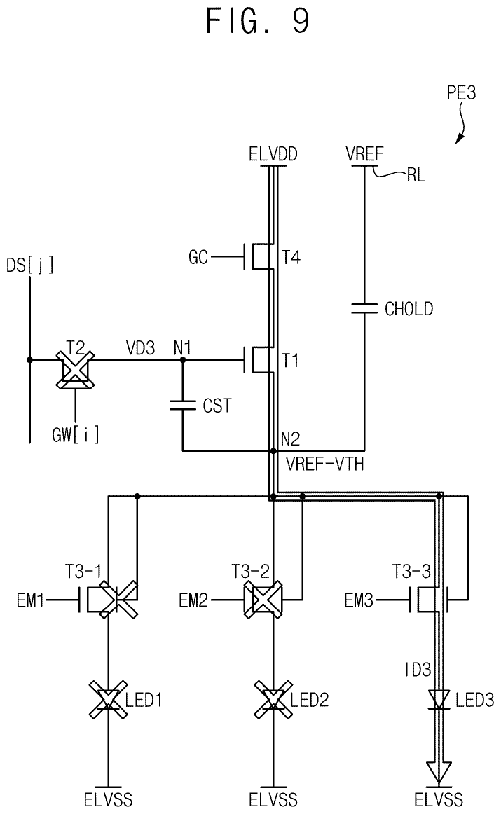

FIG. 4 is a diagram for describing the first initialization period PI1 to the third initialization period PI3 of FIG. 3, according to some example embodiments. FIG. 5 is a diagram for describing the first compensation period PC1 to the third compensation period PC3 of FIG. 3, according to some example embodiments. FIG. 6 is a diagram for describing the first addressing period PA1 to the third addressing period PA3 of FIG. 3, according to some example embodiments. FIG. 7 is a diagram for describing the first emission period PE1 of FIG. 3, according to some example embodiments. FIG. 8 is a diagram for describing the second emission period PE2 of FIG. 3, according to some example embodiments. FIG. 9 is a diagram for describing the third emission period PE3 of FIG. 3, according to some example embodiments.

Referring to FIGS. 3 and 4, in the first initialization period PI1, the reference voltage VREF may be applied to the first node N1 through the write transistor T2, and the first power voltage ELVDD having the low voltage level may be applied to the first terminal of the driving transistor T1 through the compensation transistor T4. In the first initialization period PI1, the driving transistor T1 may be initialized.

Referring to FIGS. 3 and 5, in the first compensation period PC1, the reference voltage VREF may be applied to the first node N1 through the write transistor T2, and a current may flow from the first power voltage ELVDD having the high voltage level to the second node N2 through the compensation transistor T4 and the driving transistor T1. Accordingly, in the first compensation period PC1, a voltage of the second node N2 may increase to a value obtained by subtracting a threshold voltage VTH of the driving transistor T1 from the reference voltage VREF, and the value obtained by subtracting the threshold voltage VTH of the driving transistor T1 from the reference voltage VREF may be applied to the second node N2. The threshold voltage VTH of the driving transistor T1 may be compensated for in the first compensation period PC1.

Referring to FIGS. 3 and 6, the first data voltage VD1 may be applied to the first node N1 through the write transistor T2 in the first addressing period PA1. A voltage difference VD1−VREF+VTH between the first node N1 and the second node N2 may be stored in the storage capacitor CST in the first addressing period PA1.

Referring to FIGS. 3 and 7, in the first emission period PE1, the driving transistor T1 may generate a first driving current ID1 corresponding to a value VD1−VREF obtained by subtracting the threshold voltage VTH of the driving transistor T1 from the voltage difference VD1−VREF+VTH between the first node N1 and the second node N2, and the first driving current ID1 may flow from the first power voltage ELVDD having the high voltage level to the second power voltage ELVSS having the low voltage level through the compensation transistor T4, the driving transistor T1, the first emission control transistor T3-1, and the first light-emitting diode LED1. Accordingly, in the first emission period PE1, the first light-emitting diode LED1 may emit light with a luminance corresponding to the first data voltage VD1.

Referring to FIGS. 3 and 4, in the second initialization period PI2, the reference voltage VREF may be applied to the first node N1 through the write transistor T2, and the first power voltage ELVDD having the low voltage level may be applied to the first terminal of the driving transistor T1 through the compensation transistor T4. In the second initialization period PI2, the driving transistor T1 may be initialized.

Referring to FIGS. 3 and 5, in the second compensation period PC2, the reference voltage VREF may be applied to the first node N1 through the write transistor T2, and a current may flow from the first power voltage ELVDD having the high voltage level to the second node N2 through the compensation transistor T4 and the driving transistor T1. Accordingly, in the second compensation period PC2, the voltage of the second node N2 may increase to a value obtained by subtracting the threshold voltage VTH of the driving transistor T1 from the reference voltage VREF, and the value obtained by subtracting the threshold voltage VTH of the driving transistor T1 from the reference voltage VREF may be applied to the second node N2. The threshold voltage VTH of the driving transistor T1 may be compensated for in the second compensation period PC2.

Referring to FIGS. 3 and 6, the second data voltage VD2 may be applied to the first node N1 through the write transistor T2 in the second addressing period PA2. A voltage difference VD2−VREF+VTH between the first node N1 and the second node N2 may be stored in the storage capacitor CST in the second addressing period PA2.

Referring to FIGS. 3 and 8, in the second emission period PE2, the driving transistor T1 may generate a second driving current ID2 corresponding to a value VD2−VREF obtained by subtracting the threshold voltage VTH of the driving transistor T1 from the voltage difference VD2−VREF+VTH between the first node N1 and the second node N2, and the second driving current ID2 may flow from the first power voltage ELVDD having the high voltage level to the second power voltage ELVSS having the low voltage level through the compensation transistor T4, the driving transistor T1, the second emission control transistor T3-2, and the second light-emitting diode LED2. Accordingly, in the second emission period PE2, the second light-emitting diode LED2 may emit light with a luminance corresponding to the second data voltage VD2.

Referring to FIGS. 3 and 4, in the third initialization period PI3, the reference voltage VREF may be applied to the first node N1 through the write transistor T2, and the first power voltage ELVDD having the low voltage level may be applied to the first terminal of the driving transistor T1 through the compensation transistor T4. In the third initialization period PI3, the driving transistor T1 may be initialized.

Referring to FIGS. 3 and 5, in the third compensation period PC3, the reference voltage VREF may be applied to the first node N1 through the write transistor T2, and a current may flow from the first power voltage ELVDD having the high voltage level to the second node N2 through the compensation transistor T4 and the driving transistor T1. Accordingly, in the third compensation period PC3, the voltage of the second node N2 may increase to a value obtained by subtracting the threshold voltage VTH of the driving transistor T1 from the reference voltage VREF, and the value obtained by subtracting the threshold voltage VTH of the driving transistor T1 from the reference voltage VREF may be applied to the second node N2. The threshold voltage VTH of the driving transistor T1 may be compensated for in the third compensation period PC3.

Referring to FIGS. 3 and 6, the third data voltage VD3 may be applied to the first node N1 through the write transistor T2 in the third addressing period PA3. A voltage difference VD3-VREF+VTH between the first node N1 and the second node N2 may be stored in the storage capacitor CST in the third addressing period PA3.

Referring to FIGS. 3 and 9, in the third emission period PE3, the driving transistor T1 may generate a third driving current ID3 corresponding to a value VD3−VREF obtained by subtracting the threshold voltage VTH of the driving transistor T1 from the voltage difference VD3−VREF+VTH between the first node N1 and the second node N2, and the third driving current ID3 may flow from the first power voltage ELVDD having the high voltage level to the second power voltage ELVSS having the low voltage level through the compensation transistor T4, the driving transistor T1, the third emission control transistor T3-3, and the third light emitting diode LED3. Accordingly, in the third emission period PE3, the third light emitting diode LED3 may emit light with a luminance corresponding to the third data voltage VD3.

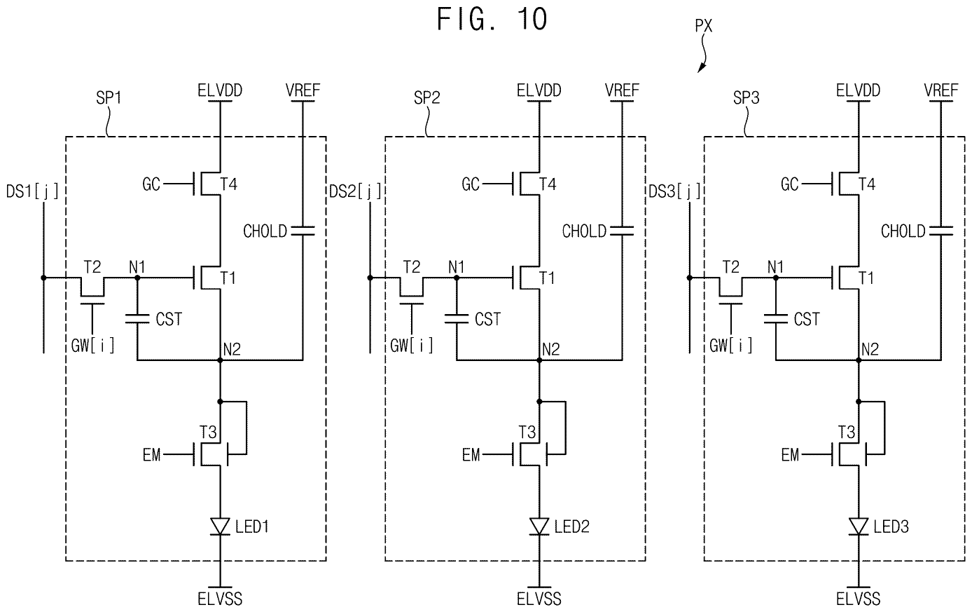

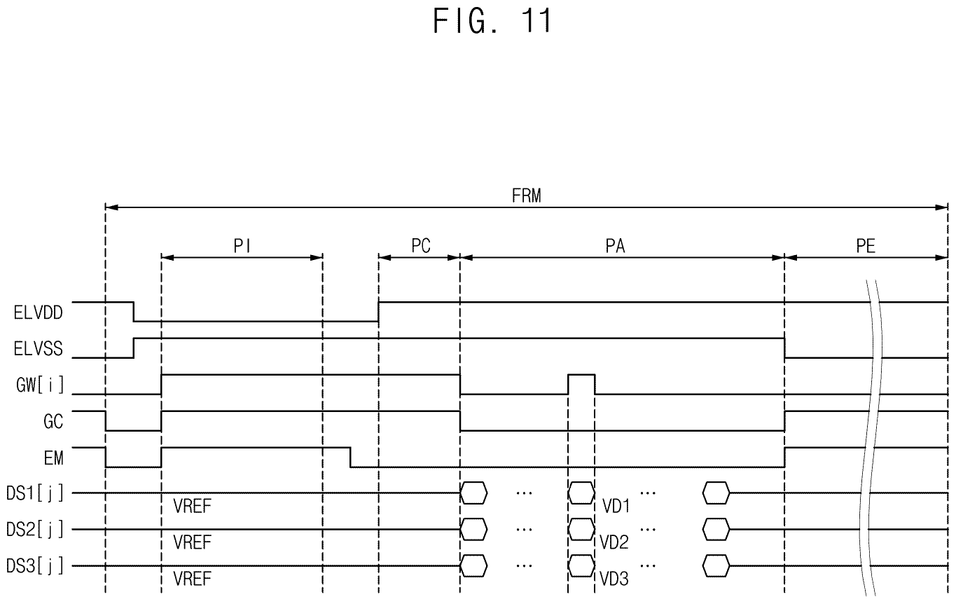

FIG. 10 is a circuit diagram illustrating a pixel PX according to the prior art. FIG. 11 is a timing diagram illustrating voltages and signals of FIG. 10.

Referring to FIGS. 2, 3, 10, and 11, in the prior art, the pixel PX may include a first sub-pixel SP1 including a first light-emitting diode LED1, a second sub-pixel SP2 including a second light-emitting diode LED2, and a third sub-pixel SP3 including a third light-emitting diode LED3, and each of the first to third sub-pixels SP1, SP2, and SP3 may include a driving transistor T1, a writing transistor T2, an emission control transistor T3, a compensation transistor T4, a storage capacitor CST, and a holding capacitor CHOLD. In the prior art, a frame period FRM may include an initialization period PI in which first nodes N1 of the first to third sub-pixels SP1, SP2, and SP3 are simultaneously initialized, a compensation period PC in which threshold voltages of the driving transistors T1 of the first to third sub-pixels SP1, SP2, and SP3 are simultaneously compensated, an addressing period PA in which first to third data voltages VD1, VD2, and VD2 are simultaneously written to the first to third sub-pixels SP1, SP2, and SP3, and an emission period PE in which the first to third light-emitting diodes LED1, LED2, and LED3 simultaneously emit light.

The pixel PX according to some example embodiments of the present inventive concepts may include six transistors and two capacitors, and the pixel PX according to the prior art may include twelve transistors and six capacitors. In some example embodiments of the present inventive concepts, the sub-pixels may share the driving transistor T1, the write transistor T2, and the compensation transistor T4 and the sub-pixels may share the storage capacitor CST and the holding capacitor CHOLD, and accordingly, an area of the pixel PX may be reduced.

In the frame period FRM (e.g., the at least one frame period FRM) of the pixel PX according to some example embodiments of the present inventive concepts, the first to third light-emitting diodes LED1, LED2, and LED3 included in the pixel PX may sequentially emit light, and in the frame period FRM of the pixel PX according to the prior art, the first to third light-emitting diodes LED1, LED2, and LED3 included in the pixel PX may simultaneously emit light. Accordingly, when a length of the frame period FRM (e.g., the at least one frame period FRM) is the same, a length of the emission period PE of each of the first to third light-emitting periods PE1, PE2, and PE3 of the pixel PX according to some example embodiments of the present inventive concepts may be about ⅓ of a length of the emission period PE of the pixel PX according to the prior art. In some example embodiments of the present inventive concepts, the low voltage level of the second power voltage ELVSS transmitted and/or sent to the pixel PX may decrease, or voltage levels of the first to third data voltages VD1, VD2, and VD3 may increase, and accordingly, a luminance of the pixel PX may be prevented and/or mitigated from decreasing and/or reducing due to the sequential emission of the first to third light-emitting diodes LED1, LED2, and LED3.

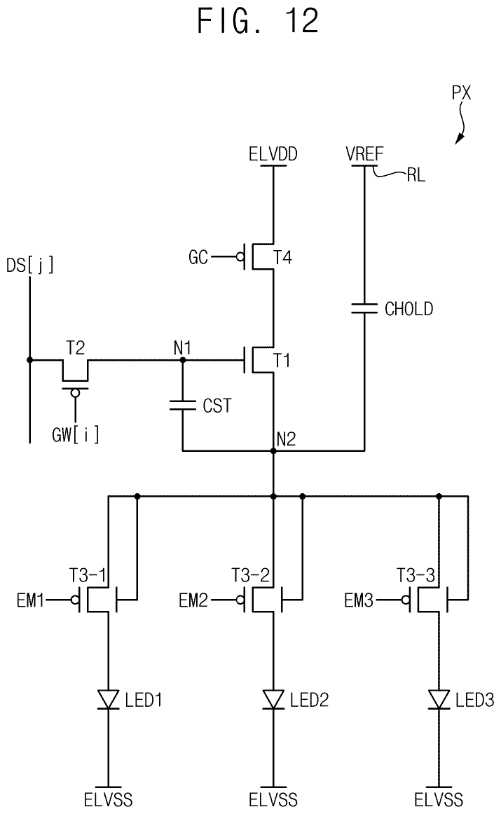

FIG. 12 is a circuit diagram illustrating an example of the pixel PX of FIG. 1, according to some example embodiments.

Descriptions of components of the pixel PX described with reference to FIG. 12, which are substantially the same as, similar to, and/or the same as those of the pixel PX described with reference to FIG. 2, are omitted.

Referring to FIG. 12, in some example embodiments, each of the writing transistor T2, the first emission control transistor T3-1, the second emission control transistor T3-2, the third emission control transistor T3-3, and the compensation transistor T4 may be a p-channel metal oxide semiconductor (PMOS) transistor.

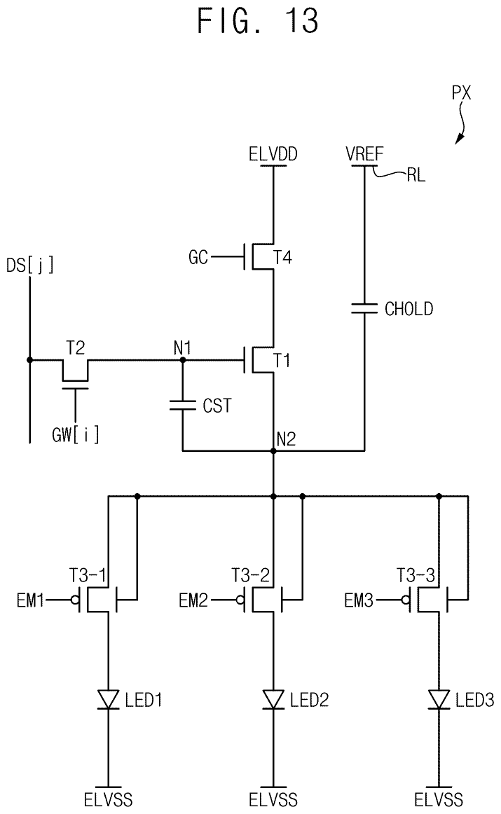

FIG. 13 is a circuit diagram illustrating an example of the pixel PX of FIG. 1, according to some example embodiments.

Descriptions of components of the pixel PX described with reference to FIG. 13, which are substantially the same as, similar to, and/or the same as those of the pixel PX described with reference to FIG. 2, are omitted.

Referring to FIG. 13, in some example embodiments, at least one of the writing transistor T2, the first emission control transistor T3-1, the second emission control transistor T3-2, the third emission control transistor T3-3, and the compensation transistor T4 may be an NMOS transistor, and at least one other one of the writing transistor T2, the first emission control transistor T3-1, the second emission control transistor T3-2, the third emission control transistor T3-3, and the compensation transistor T4 may be a PMOS transistor. FIG. 13 illustrates an example embodiment in which each of the write transistor T2 and the compensation transistor T4 is an NMOS transistor, and each of the first emission control transistor T3-1, the second emission control transistor T3-2, and the third emission control transistor T3-3 is a PMOS transistor, but example embodiments of the present inventive concepts are not limited thereto.

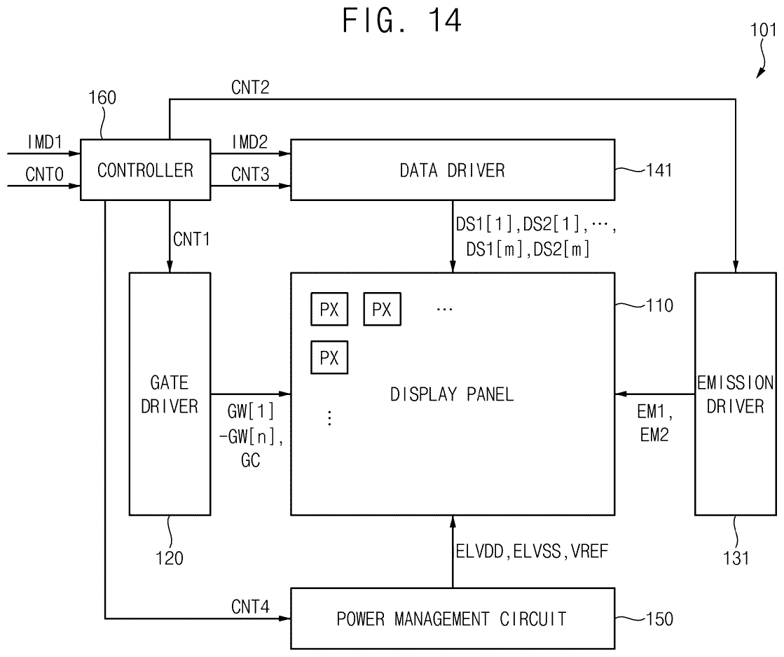

FIG. 14 is a block diagram illustrating a display device 101 according to some example embodiments.

Descriptions of components of the display device 101 described with reference to FIG. 14, which are substantially the same as, similar to, and/or the same as those of the display device 100 described with reference to FIG. 1, are omitted.

Referring to FIG. 14, the display device 101 may include the display panel 110, the gate driver 120, an emission driver 131, a data driver 141, the power management circuit 150, and the controller 160.

The emission driver 131 may provide a first emission control signal EM1 and a second emission control signal EM2 to the pixels PX. The emission driver 131 may generate the first emission control signal EM1 and the second emission control signal EM2 based on the second control signal CNT2.

In some example embodiments, the compensation gate signal GC, the first emission control signal EM1, and the second emission control signal EM2 may be simultaneously transmitted and/or sent to the first to n^{th} pixel rows.

The data driver 141 may provide first first and second data signals to m^{th} first and second data signals DS1[1], DS2[1], ..., DS1[m], and DS2[m] to the pixels PX. For example, the data driver 141 may provide a first (e.g., 1^{st}) first data signal DS1[1] to a m^{th} first data signal DS1[m] to the pixels PX and a first second data signal DS2[1] to a m^{th} second data signal DS2[m] to the pixels PX. The data driver 141 may generate the first first and second data signals to the m^{th} first and second data signals DS1[1], DS2[1], ..., DS1[m], and DS2[m] based on the output image data IMD2 and the third control signal CNT3. For example, the data driver 141 may generate the first (e.g., 1^{st}) first data signal DS[1] to the m^{th} first data signal DS1[m] and may generate the first second data signal DS2[1] to the m^{th} second data signal DS2[m] based on the output image data IMD2 and the third control signal CNT3.

The controller 160 may control the gate driver 120, the emission driver 131, the data driver 141, and the power management circuit 150.

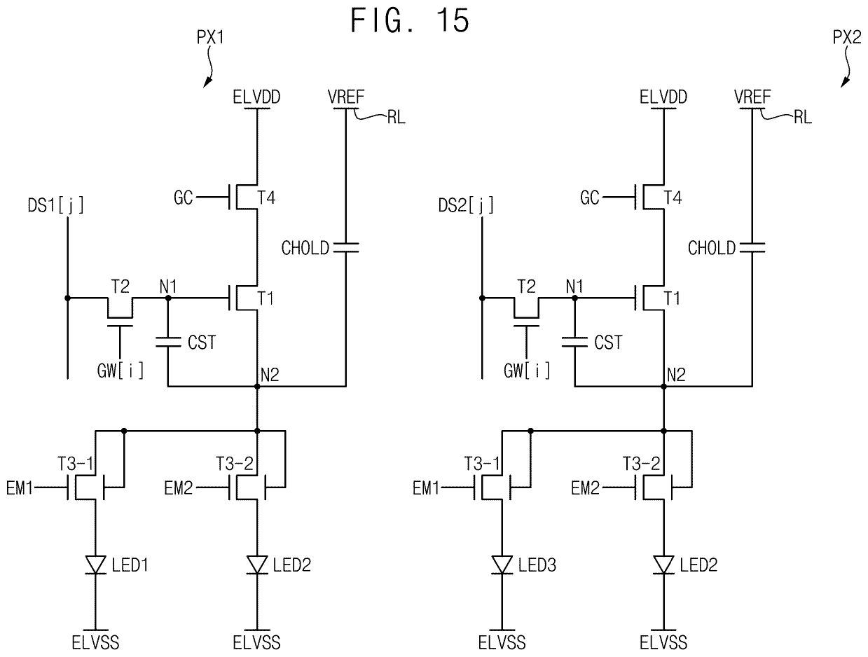

FIG. 15 is a circuit diagram illustrating an example of the pixel PX of FIG. 14, according to some example embodiments. FIG. 15 may illustrate first and second pixels PX1 and PX2 positioned in the i^{th} pixel row and the j^{th} pixel column.

Descriptions of components of the first and second pixels PX1 and PX2 described with reference to FIG. 15, which are substantially the same as, similar to, and/or the same as those of the pixel PX described with reference to FIG. 2, are omitted.

Referring to FIG. 15, each of the first and second pixels PX1 and PX2 may receive the write gate signal GW[i], the first emission control signal EM1, the second emission control signal EM2, the compensation gate signal GC, the first power voltage ELVDD, the second power voltage ELVSS, and the reference voltage VREF. The first pixel PX1 may receive the first data voltage DS1[j], and the second pixel PX2 may receive the second data voltage DS2[j]. Each of the first and second pixels PX1 and PX2 may include the driving transistor T1, the writing transistor T2, a first emission control transistor T3-1, a second emission control transistor T3-2, the compensation transistor T4, the storage capacitor CST, and the holding capacitor CHOLD. The first pixel PX1 may include the first light-emitting diode LED1 and the second light-emitting diode LED2, and the second pixel PX2 may include the third light-emitting diode LED3 and the second light-emitting diode LED2.

The writing transistor T2 of the first pixel PX1 may transmit and/or send the first data signal DS1[j] to the first node N1 in response to the writing gate signal GW[i]. The writing transistor T2 of the second pixel PX2 may transmit and/or send the second data signal DS2[j] to the first node N1 in response to the writing gate signal GW[i].

The first emission control transistor T3-1 of the first pixel PX1 may connect the second node N2 to the first terminal of the first light-emitting diode LED1 in response to the first emission control signal EM1. The second emission control transistor T3-2 of the first pixel PX1 may connect the second node N2 to the first terminal of the second light-emitting diode LED2 in response to the second emission control signal EM2.

The first emission control transistor T3-1 of the second pixel PX2 may connect the second node N2 to the first terminal of the third light-emitting diode LED3 in response to the first emission control signal EM1. The second emission control transistor T3-2 of the second pixel PX2 may connect the second node N2 to the first terminal of the second light-emitting diode LED2 in response to the second emission control signal EM2.

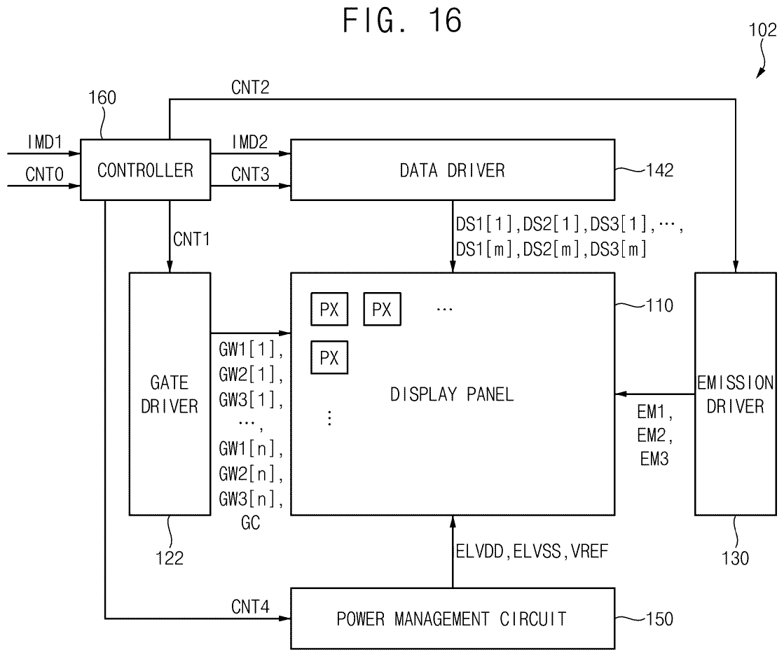

FIG. 16 is a block diagram illustrating a display device 102 according to some example embodiments.

Descriptions of components of the display device 102 described with reference to FIG. 16, which are substantially the same as, similar to, and/or the same as those of the display device 100 described with reference to FIG. 1, are omitted.

Referring to FIG. 16, the display device 102 may include the display panel 110, a gate driver 122, the emission driver 130, a data driver 142, the power management circuit 150, and the controller 160.

The gate driver 122 may provide first first, second, and third write gate signals to n^{th} first, second, and third write gate signals GW1[1], GW2[1], GW3[1], ..., GW1[n], GW2[n], and GW3[n] and the compensation gate signal GC to the pixels PX. For example, the gate driver 122 may provide the first first write gate signal GW1[1], the first second write gate signal GW2[1], and the first third write gate signal GW3[1] to the n^{th} first write gate signal GW1[n], the n^{th} second write gate signal GW2[n], and the n^{th} third write gate signal GW3[n], and the compensation gate signal GC to the pixels PX. The gate driver 122 may generate the first first, second, and third write gate signals to the n^{th} first, second, and third write gate signals GW1[1], GW2[1], GW3[1], . . . , GW1[n], GW2[n], and GW3[n] and the compensation gate signal GC based on the first control signal CNT1. For example, the gate driver 122 may generate the first first write gate signal GW1[1], the first second write gate signal GW2[1], and the first third write gate signal GW3[1] to the n^{th} first write gate signal GW1[n], the n^{th} second write gate signal GW2[n], and the n^{th} third write gate signal GW3[n], and the compensation gate signal GC based on the first control signal CNT1.

In some example embodiments, the first first, second, and third write gate signals to the n^{th} first, second, and third write gate signals GW1[1], GW2[1], GW3[1], . . . , GW1[n], GW2[n], and GW3[n] may be sequentially transmitted and/or sent to the first to n^{th} pixel rows. For example, the first first write gate signal GW1[1], the first second write gate signal GW2[1], and the first third write gate signal GW3[1] to the n^{th} first write gate signal GW1[n], the n^{th} second write gate signal GW2[n], and the n^{th} third write gate signal GW3[n] may be sequentially transmitted and/or sent to the first pixel row to the n^{th} pixel row.

The data driver 142 may provide first first, second, and third data signals to m^{th} first, second, and third data signals DS1[1], DS2[1], DS3[1], . . . , DS1[m], DS2[m], and DS3[m] to the pixels PX. For example, the data driver 142 may provide the first first data signal DS1[1], the first second data signal DS2[1], and the first third data signal DS3[1] to the m^{th} first data signal DS1[m], the m^{th} second data signal DS2[m], and the m^{th} third data signal DS3[m] to the pixels PX. The data driver 142 may generate the first first, second, and third data signals to the m^{th} first, second, and third data signals DS1[1], DS2[1], DS3[1], . . . , DS1[m], DS2[m], and DS3[m] based on the output image data IMD2 and the third control signal CNT3. For example, the data driver 142 may generate the first first data signal DS1[1], the first second data signal DS2[1], and the first third data signal DS3[1] to the m^{th} first data signal DS1[m], the m^{th} second data signal DS2[m], and the m^{th} third data signal DS3[m] based on the output image data IMD2 and the third control signal CNT3.

The controller 160 may control the gate driver 122, the emission driver 130, the data driver 142, and the power management circuit 150.

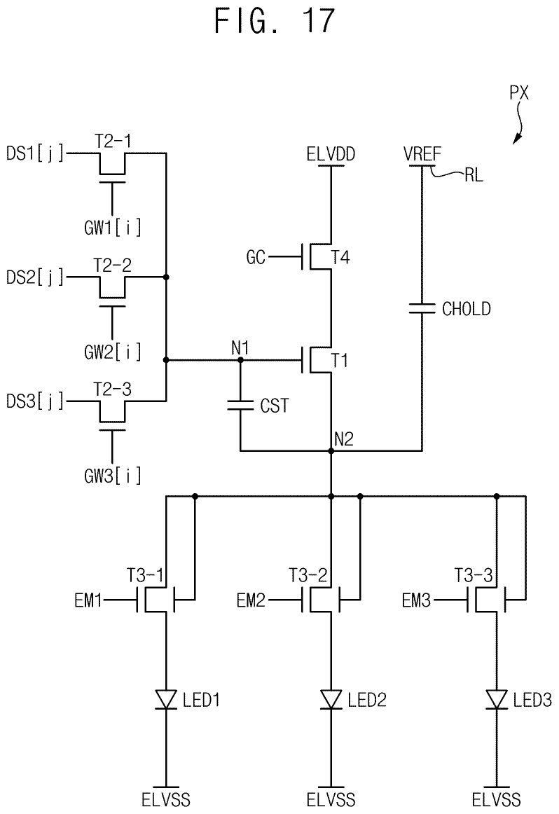

FIG. 17 is a circuit diagram illustrating an example of the pixel PX of FIG. 16, according to some example embodiments. FIG. 17 may illustrate a pixel PX positioned in the i^{th} pixel row and the j^{th} pixel column, according to some example embodiments.

Descriptions of configurations of the pixel PX described with reference to FIG. 17, which are substantially the same as, similar to, and/or the same as those of the pixel PX described with reference to FIG. 2, are omitted.

Referring to FIG. 17, the pixel PX may receive the first writing gate signal GW1[i], the second writing gate signal GW2[i], the third writing gate signal GW3[i], the first emission control signal EM1, the second emission control signal EM2, the third emission control signal EM3, the compensation gate signal GC, the first data signal DS1[j], the second data signal DS2[j], the third data signal DS3[j], the first power voltage ELVDD, the second power voltage ELVSS, and the reference voltage VREF. The pixel PX may include the first light-emitting diode LED1, the second light-emitting diode LED2, the third light-emitting diode LED3, the driving transistor T1, a first write transistor T2-1, a second write transistor T2-2, a third write transistor T2-3, the first emission control transistor T3-1, the second emission control transistor T3-2, the third emission control transistor T3-3, the compensation transistor T4, the storage capacitor CST, and the holding capacitor CHOLD.

The first write transistor T2-1 may transmit and/or send the first data signal DS1[j] to the first node N1 in response to the first write gate signal GW1[i]. The first write transistor T2-1 may include a gate that receives the first write gate signal GW1[i], a first terminal (e.g., one of a source and a drain) that receives the first data signal DS1[j], and a second terminal (e.g., the other one of the source and the drain) connected to the first node N1.

The second write transistor T2-2 may transmit and/or send the second data signal DS2[j] to the first node N1 in response to the second write gate signal GW2[i]. The second write transistor T2-2 may include a gate that receives the second write gate signal GW2[i], a first terminal (e.g., one of a source and a drain) that receives the second data signal DS2[j], and a second terminal (e.g., the other one of the source and the drain) connected to the first node N1.

The third write transistor T2-3 may transmit and/or send the third data signal DS3[j] to the first node N1 in response to the third write gate signal GW3[i]. The third write transistor T2-3 may include a gate that receives the third write gate signal GW3[i], a first terminal (e.g., one of a source and a drain) that receives the third data signal DS3[j], and a second terminal (e.g., the other one of the source and the drain) connected to the first node N1.

In some example embodiments, each of the first write transistor T2-1, the second write transistor T2-2, and the third write transistor T2-3 may be an NMOS transistor. In some example embodiments, each of the first write transistor T2-1, the second write transistor T2-2, and the third write transistor T2-3 may be a PMOS transistor.

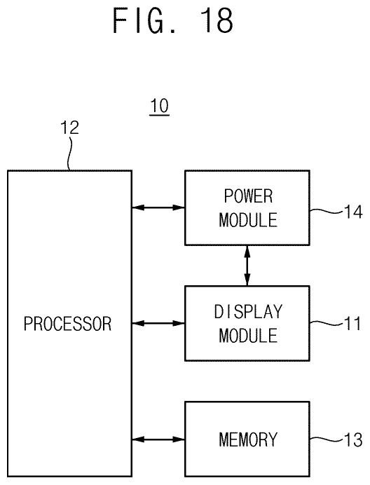

FIG. 18 is a block diagram illustrating an electronic device 10 according to some example embodiments.

Referring to FIG. 18, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and/or a controller. The processor 12 may control the display module 11.

The memory 13 may store data information for an operation of the processor 12 and/or the display module 11. For example, the memory 13 may store data information advantageous for an operation of the processor 12 and/or the display module 11. When the processor 12 executes an application stored in the memory 13, the input image data IMD1 of FIGS. 1, 14, and/or 16 and the control signal CNT0 of FIGS. 1, 14, and/or 16 may be transmitted and/or sent to the display module 11, and the display module 11 may output image information based on the input image data IMD1 and the control signal CNT0.

The power module 14 may include a power supply module such as a power adapter, a battery device, etc. and a power conversion module that converts power supplied by the power supply module to generate power for an operation of the electronic device 10.

At least one of the components of the electronic device 10 described above may be included in the display device 100, 101, and/or 102 of FIG. 1, FIG. 14, and/or FIG. 16, according to some example embodiments as described above. Some of the individual modules functionally included in one module may be included in the display device 100, 101, or 102, and others may be provided separately from the display device 100, 101, or 102. For example, the display device 100, 101, or 102 may include the display module 11, and the processor 12, the memory 13, and the power module 14 may be provided in the form of other devices within the electronic device 11 other than the display device 100, 101, or 102.

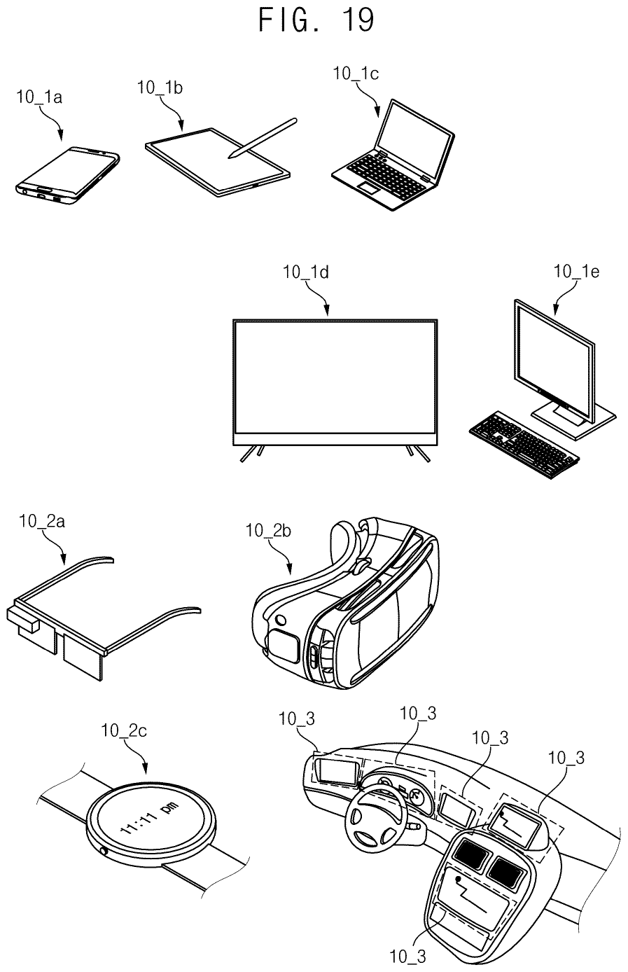

FIG. 19 is a diagram illustrating electronic devices according to some example embodiments.

Referring to FIG. 19, some electronic devices to which display devices according to some example embodiments are applied may include not only image display electronic devices such as a smart phone 10_1a, a tablet PC 10_1b, a laptop 10_1c, a TV 10_1d, a desk monitor 10_1e, etc., but may also include wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display CID arranged on a dashboard, a room mirror display, etc., but example embodiments are not limited thereto.

The display panel according to some example embodiments may be applied to a display device included in a computer, a notebook, a mobile phone, a smart phone, a smart pad, a smart watch, a PMP, a PDA, an MP3 player, and/or the like.

As described herein, any devices, systems, modules, portions, units, controllers, circuits, and/or portions thereof according to any of the example embodiments, and/or any portions thereof may include, may be included in, and/or may be implemented by one or more instances of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), a programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions, and a processor (e.g., CPU) configured to execute the program of instructions to implement the functionality and/or methods performed by some or all of any devices, systems, modules, portions, units, controllers, circuits, and/or portions thereof according to any of the example embodiments.

Although the display panel and/or the electronic device according to some example embodiments have been described with reference to the drawings, the illustrated example embodiments are examples, and may be modified and changed by a person having ordinary skill in the art without departing from the technical spirit and scope described in the following claims.

What is claimed is:

1. A display panel, comprising:
a pixel, the pixel including,
a first light-emitting diode configured to emit light having a first color;
a second light-emitting diode configured to emit light having a second color different from the first color;
a driving transistor including a gate connected to a first node, a first terminal, and a second terminal connected to a second node;
a first write transistor configured to send a first data signal to the first node in response to a first write gate signal;
a storage capacitor connected between the first node and the second node;
a first emission control transistor configured to connect the second node to a first terminal of the first light-emitting diode in response to a first emission control signal; and
a second emission control transistor configured to connect the second node to a first terminal of the second light-emitting diode in response to a second emission control signal,
the display panel configured to display an image frame in a frame period, the frame period including
a first sub-frame period including a first addressing period that a first data voltage is applied to the first node and a first emission period that the first light-emitting diode is configured to emit light with a luminance corresponding to the first data voltage, and
a second sub-frame period following the first sub-frame period, the second sub-frame period including a second addressing period that a second data voltage is applied to the first node and a second emission period that the second light-emitting diode is configured to emit light with a luminance corresponding to the second data voltage.

2. The display panel of claim 1, wherein the pixel further comprises:
a compensation transistor configured to send a first power voltage to the first terminal of the driving transistor in response to a compensation gate signal.

3. The display panel of claim 1, wherein the pixel further comprises:
a holding capacitor connected between the second node and a reference line configured to send a reference voltage.

4. The display panel of claim 1, wherein the first data signal has the first data voltage in the first addressing period and the second data voltage in the second addressing period.

5. The display panel of claim 1, wherein
the first sub-frame period further includes a first initialization period that a reference voltage is applied to the first node and a first compensation period that a value obtained by subtracting a threshold voltage of the driving transistor from the reference voltage is applied to the second node, and
the second sub-frame period further includes a second initialization period that the reference voltage is applied to the first node and a second compensation period that the value obtained by subtracting the threshold voltage of the driving transistor from the reference voltage is applied to the second node.

6. The display panel of claim 5, wherein the first data signal has the reference voltage in the first initialization period, the first compensation period, the second initialization period, and the second compensation period.

7. The display panel of claim 1, wherein the pixel further comprises:
a third light-emitting diode configured to emit light having a third color different from the first color and the second color; and
a third emission control transistor configured to connect the second node to a first terminal of the third light-emitting diode in response to a third emission control signal.

8. The display panel of claim 7, wherein the frame period further comprises:
a third sub-frame period following the second sub-frame period, the third sub-frame period including a third addressing period that a third data voltage is applied to the first node and a third emission period that the third light-emitting diode is configured to emit light with a luminance corresponding to the third data voltage.

9. The display panel of claim 1, wherein the driving transistor is an n-channel metal oxide semiconductor (NMOS) transistor.

10. The display panel of claim 9, wherein each of the first write transistor, the first emission control transistor, and the second emission control transistor is an NMOS transistor.

11. The display panel of claim 9, wherein each of the first write transistor, the first emission control transistor, and the second emission control transistor is a p-channel metal oxide semiconductor (PMOS) transistor.

12. The display panel of claim 9, wherein
at least one of the first write transistor, the first emission control transistor, and the second emission control transistor is an NMOS transistor, and
at least one other one of the first write transistor, the first emission control transistor, and the second emission control transistor is a PMOS transistor.

13. The display panel of claim 1, wherein the pixel further comprises:
a second write transistor configured to send a second data signal to the first node in response to a second write gate signal; and
a third write transistor configured to send a third data signal to the first node in response to a third write gate signal.

14. An electronic device, comprising:
a display panel including pixels;
a gate driver configured to output a first write gate signal to each of the pixels;
an emission driver configured to output a first emission control signal and a second emission control signal to each pixel of the pixels; and
a data driver configured to output a first data signal to each pixel of the pixels, each pixel of the pixels including,
a first light-emitting diode configured to emit light having a first color;
a second light-emitting diode configured to emit light having a second color different from the first color;
a driving transistor including a gate connected to a first node, a first terminal, and a second terminal connected to a second node;
a first write transistor configured to send the first data signal to the first node in response to the first write gate signal;
a storage capacitor connected between the first node and the second node;
a first emission control transistor configured to connect the second node to a first terminal of the first light-emitting diode in response to the first emission control signal; and
a second emission control transistor configured to connect the second node to a first terminal of the second light-emitting diode in response to the second emission control signal, and
the display panel configured to display an image frame in a frame period, the frame period including,
a first sub-frame period including a first addressing period that a first data voltage is applied to the first node and a first emission period that the first light-emitting diode is configured to emit light with a luminance corresponding to the first data voltage; and
a second sub-frame period following the first sub-frame period, the second sub-frame period including a second addressing period that a second data voltage is applied to the first node and a second emission period that the second light-emitting diode is configured to emit light with a luminance corresponding to the second data voltage.

15. The electronic device of claim 14, wherein
the gate driver is configured to further output a compensation gate signal to each pixel of the pixels, and
each pixel of the pixels further includes a compensation transistor configured to send a first power voltage to the first terminal of the driving transistor in response to the compensation gate signal.

16. The electronic device of claim 15, wherein the first write gate signal is sequentially sent to pixel rows of the display panel.

17. The electronic device of claim 15, wherein the first emission control signal, the second emission control signal, and the compensation gate signal are simultaneously sent to pixel rows of the display panel.

18. The electronic device of claim 14, wherein each pixel of the pixels further comprises a holding capacitor connected between the second node and a reference line configured to send a reference voltage.

19. The electronic device of claim 14, wherein the driving transistor is an n-channel metal oxide semiconductor (NMOS) transistor.

20. The electronic device of claim 19, wherein each of the first write transistor, the first emission control transistor, and the second emission control transistor is an NMOS transistor.
